(19) United States
(12) Patent Application Publication
(10) Pub. No.: US 2013/0098381 A1
(43) Pub. Date: Apr. 25, 2013

(54) SOAP POCKET SCRUBBER SYSTEM

(71) Applicant: Janel L. McBrayer, North Olmsted, OH (US)

(72) Inventor: Janel L. McBrayer, North Olmsted, OH (US)

(21) Appl. No.: 13/331,875

(22) Filed: Dec. 20, 2011

Related U.S. Application Data
(60) Provisional application No. 61/551,012, filed on Oct. 25, 2011.

(51) Int. Cl. A47K 7/02; A47K 7/03; B08B 1/00

(52) U.S. Cl. 132/200; 15/210.1

(57) ABSTRACT

A multi-compartment pocket system to be used for scrubbing difficult-to-reach areas of the body without the help of a second person. The device comprises a plurality of pockets for holding bars of soap, each with a closeable hook and loop fabric system, and a first end rope forming a loop, and a second end rope forming a loop. The first end rope is gripped by a first hand and the second end rope is gripped by the other hand and with the multi-compartment pocket system wetted and the soap lathered, the device is pulled back and forth across hard-to-reach areas of the body for cleaning.

### CROSS-REFERENCE TO RELATED APPLICATION

The present application is related to and claims priority from prior provisional application Ser. No. 61/551,012, filed Oct. 25, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently-described or claimed inventions, or that any publication or document that is specifically or implicitly referenced is prior art.

### 1. Field of the Invention

The present invention relates generally to the field of bathing implements and more specifically relates to soap scrubbers for use on difficult-to-reach areas of the body.

### 2. Description of the Related Art

Throughout the centuries, different practices have been used by different societies in the bathing process. One thing that has remained constant though, is the difficulty in cleaning some hard-to-reach areas of the body. The human body due to its shape may make it difficult to reach certain areas such as, for example the middle of the back. Individuals that are aged, have disabilities, or are overweight may have a much greater difficulty cleaning all areas and may tend to disregard these areas unless a second person is available to help. This may lead to individuals not being cleaned adequately or alternately may be embarrassing to have other individuals present during the bathing process.

In modern society, bar soap is almost universally used to cleanse the body in combination with a washcloth. Bar soap by itself is slippery when wet and lacks the abrasive qualities needed to effectively remove dirt and exfoliate the skin. A washcloth may or may not significantly help in dirt removal and in exfoliating the skin. Exfoliation involves the removal of the dead skin cells on the skin's outermost surface. After the exfoliation process, new skin cells are created by the body in the skids lower layer, the dermis. Exfoliation removes the outer layer to reveal the newer skin beneath. This shedding of the outer layer unclogs pores, keeps skin clean, and helps reduce acne breakouts. It is desirable to encourage exfoliating processes however traditional washing means do not normally provide for this advantage and thus may not promote healthy skin.

The process of obtaining lather from a bar of soap is generally achieved by agitating the bar within a folded washcloth. When sufficient lather is achieved, the bar of soap is placed in a dish and the washcloth is used in a mildly abrasive fashion. The process is repeated while bathing as many times as needed. This lathering process is done in this fashion because washcloths are made of a weave that tends to hold lather and hinder the lather from passing through the cloth. Traditional processes may be inefficient; they could be improved if the fabric used allowed the lather to pass easily through while possessing a mildly abrasive quality. The result of using this process with traditional implements is time wasted. In a busy society, efficiency of time is important. Another waste is the amount of water that unnecessarily runs down the drain in the meantime, which may be expensive and damage the environment. The cumulative effect per person of this waste, over a long period, can have a significant impact on the loss of natural resources. As the bar of soap becomes too small to lather efficiently or to hold onto, it is usually just discarded, which in itself is a small waste, but may be cumulative in its effect. It is desirable to minimize waste.

Various attempts have been made to solve the above-mentioned problems such as those found in U.S. Pat. Nos. 2008/0205962; 6,015,242; 4,228,834; 2009/0071849; 7,473,044; and 6,227,742. This prior art is representative of bathing implements. None of the above inventions and patents, taken either singly or in combination, is seen to describe the invention as claimed.

Ideally, a soap scrubber for use in reaching difficult-to-reach areas of the body should be easy to use, durably constructed and contain soap of various sizes for entirely consuming the bar of soap, and yet, would operate reliably and may be manufactured at a modest expense. Thus, a need exists for a reliable soap pocket scrubber system to avoid the above-mentioned problems.

### BRIEF SUMMARY OF THE INVENTION

In view of the foregoing disadvantages inherent in the known bathing implement art, the present invention provides a novel soap pocket scrubber system. The general purpose of the present invention, which will be described subsequently in greater detail, is to provide easy access for bather-users to access difficult to reach areas of the body during washing and exfoliation processes.

A soap pocket scrubber system is disclosed herein preferably comprising a multi-compartment pocket system having a first side, a second side, a front edge having a top fabric hook system and a bottom fabric loop system, a back edge, a first end having a first end rope, and a second end having a second end rope. The multi-compartment pocket system generally comprises a plurality of compartments preferably aligned side by side wherein the compartments span the entire area of the device such that there is no wasted material and unusable portions. In preferred embodiments usable compartments are located directly adjacent edges of the device. The multi-compartment pocket system in a preferred embodiment may comprise three compartments but in some embodiments may have as few as one compartment, yet in other embodiments may have four or more compartments. The soap pocket(s) of the multi-compartment pocket system are about 4 inches long and about 4½ inches wide each, enough to contain one standard size bar of soap of approximately 5 ounces. The soap pocket(s) are able to contain multiple smaller bars of soap or soap fragments and slivers so as to completely utilize each one until gone.

The multi-compartment pocket system preferably comprises a nylon net material made of mesh that is light weight and has an ability to increase lather of the bars of soap (by holding it within the netting structure.) The nylon net material is easily rinsed and dries quickly, thereby hindering bacterial growth. The soap pocket scrubber system is non-disposable in preferred embodiments and has an extended use-life. Other versions may be disposable.

The multi-compartment pocket system is about 16 inches long and about 6 inches wide and may have multiple layers of nylon net material which may have various combinations of colors, images, or sports logos. Each of the compartments (from edge to edge) comprises an opening in the front edge such that at least one bar of soap is insertable within a compartment and closeable to contain the bar of soap with a top fabric hook system and a bottom fabric loop system. The seams of the front edge of the multi-compartment pocket system may comprise a French Seam to cover a hook and loop fastening system. French seams are preferably on all sewn sides/ends. The French seam is desirable to both aesthetically cover the preferred one-piece hook and loop fastener assembly (one-piece Velcro® hook and loop construction is preferably used to minimize manufacturing costs incurred by individual cutting and sewing costs and to increase securing surface area) and secondly to provide a grasping means for separating the hook and loop securing system; especially useful when hands are wet and slippery. The device may have color-matching thread or not, and may be made in many different designs as per user-preference. Colors may be chosen to represent company, holiday, school, sport team, or any other special occasion.

The multi-compartment pocket system may comprise a permeable mesh fabric such that a bar of soap, when liquefied, can pass therethrough. The front edge of the multi-compartment pocket system has the top fabric hook system and bottom fabric loop system which may be about 1 inch wide and about 16 inches long and are removably coupleable such that at least one bar of soap is able to be inserted and contained in each compartment. The back end may comprise folded fabric so as to contain the bar(s) of soap within the compartment(s) but in some embodiments, may have a sewed seam. The first end rope comprises a first loop located on first end and second end rope comprises a second loop located on second end which may be about 8 inches long. ¼″ polypropylene rope loop handles are located at the two opposing ends. 17″ of rope is folded in half giving a loop of an 8″ minimum, which the inventor has found to work well. The loops are sufficiently sized to allow for ease of egress of the user-bather's hand(s), also making the device easy to hang on a variety of different sized hangers, require a minimum of material, and don't easily fray. The multi-compartment pocket system may comprise a nylon net material that is light weight and provides for exfoliation of skin of a bather-user. It is preferred to use 8-ply, 4 to each side of the pocket for durability. The bather-user is able to hold the multi-compartment pocket system via the first and second loops to administer lather from bars of soap to virtually any bodily surface including hard-to-reach areas of the body.

In manufacturing, a 3-pocket scrubber uses ⅓ yard of fabric with no waste. What starts out as four layers of nylon net measuring 18″×12″ ends up as eight layers approximately 16″×4½″ to 5″ after all sewing is completed. Depending on how precisely the nylon net fabric was cut from the very start, pockets can be as large as approximately 5″×5″. Hook fastener is sewn onto one long edge, folded over to create the French seam, and then stitched again. The same process is repeated on the other long edge with the loop half of the fastener. Rope is measured, cut, singed on the ends to prevent fraying, and inserted into the inside-out folded scrubber. The ends are stitched forward and back four times, creating a strong stitch line. The very edge of the stitch line, over the hook/loop part is stitched an additional four times to ensure additional strength when being pulled open. After both ends are sewn shut, the scrubber is turned the right side out, folding it into thirds, ironing seam lines, and then repeating the multiple stitching process to create pockets with strong stitch lines between each pocket, and over the hook/loop sides. A 4-pocket scrubber with French seams requires more than ⅓ yard of fabric, thus may create waste. In preferred embodiments with 3 pockets logos may be sewn (or attached) on both sides on the center pocket. On versions with even numbers of pockets (2, 4, etc.) the logos may be sewn on both sides on the two end pockets. This feature adds aesthetic appeal and does not obstruct the use of the device if attached back-to-back along the hook/loop area of the scrubber. If a logo were attached elsewhere, it could complicate construction/manufacture of the device, and interfere with function.

A method of use for a soap pocket scrubber system is also disclosed herein which may comprise the steps of: uncoupling the hook and loop fastening system for each compartment of the soap pocket scrubber system; inserting a bar of soap in each compartment; coupling the hook and loop fastening system for each compartment of the soap pocket scrubber system; soaking and lathering the soap pocket scrubber system; using the soap pocket scrubber system by gripping a first end rope in one hand and a second end rope in another hand and pulling back and forth across a hard-to-reach area of a body of a user; and then rinsing the soap pocket scrubber system for hang-drying. Bars of soap may be added as needed. Further, when using body wash or liquid soap, pockets need not be opened. The scrubber may be wet, liquid soap or body wash applied, the scrubber rubbed against itself to create lather, and then used against the body. The soap and the scrubber become as a single unit once soap is placed into a pocket.

The present invention holds significant improvements and serves as a soap pocket scrubber system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage, or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, soap pocket scrubber system, constructed and operative according to the teachings of the present invention.

FIG. 1 shows a perspective view illustrating a soap pocket scrubber system in an in-use condition according to an embodiment of the present invention.

FIG. 2 is a side perspective view illustrating the soap pocket scrubber system according to an embodiment of the present invention of FIG. 1.

FIG. 3 is another perspective view illustrating insertion of soap bars into compartments located in the soap pocket scrubber system according to an embodiment of the present invention of FIGS. 1 and 2.

FIG. 4 is a perspective view illustrating the soap pocket scrubber system hang-drying according to an embodiment of the present invention of FIG. 1.

FIG. 5 is a flowchart illustrating a method of use of the soap pocket scrubber system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a bathing implement device and more particularly to a soap pocket scrubber system as used to provide ease to access for use in reaching and cleaning difficult-to-reach areas of the body for both washing and exfoliation.

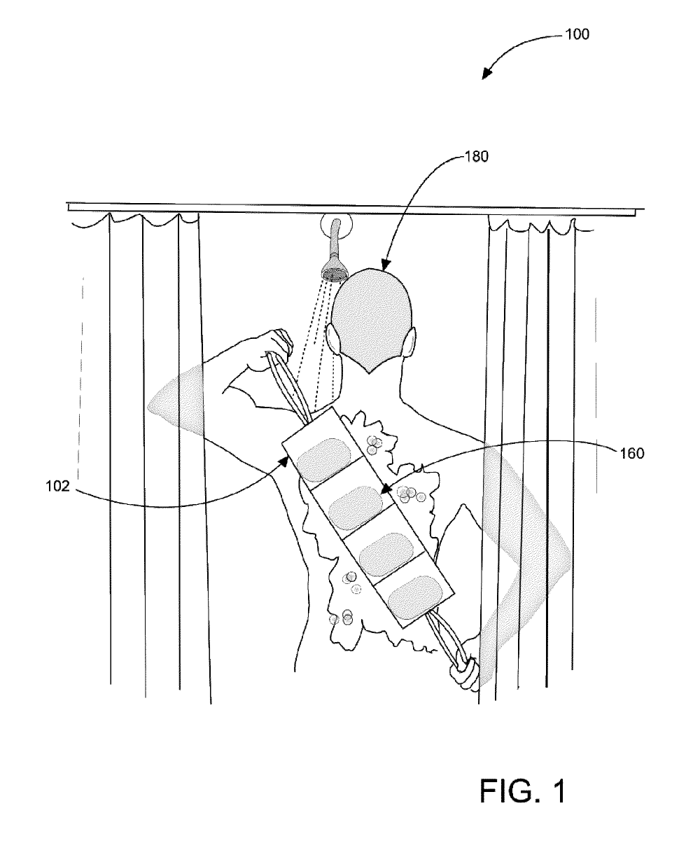

Referring to the drawings by numerals of reference there is shown in FIG. 1, a perspective view illustrating an in-use condition of soap pocket scrubber system 100 according to an embodiment of the present invention.

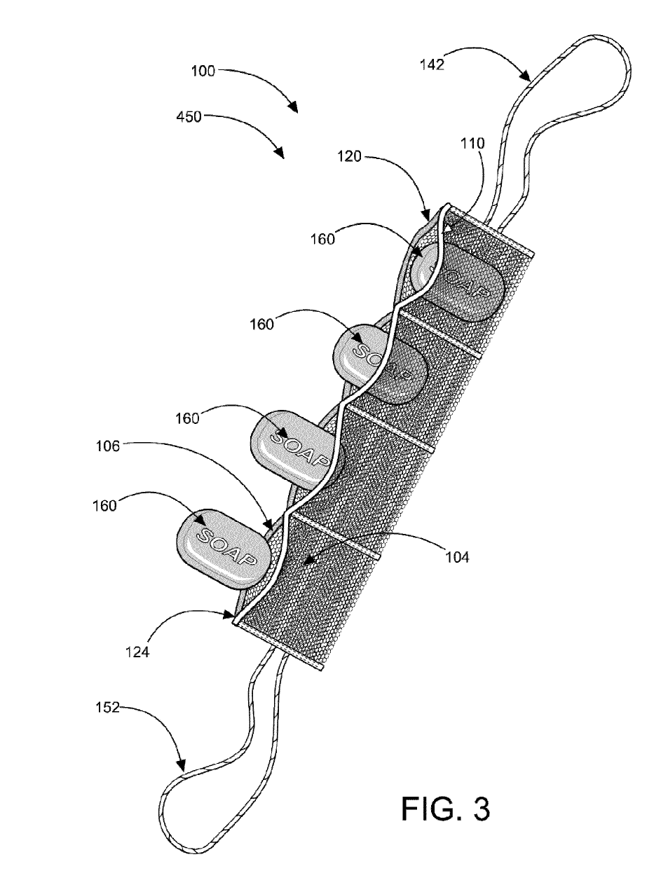

Soap pocket scrubber system 100 is a multi-compartment pocket system 102 comprising first side 104, second side 106, front edge 108 (comprising top fabric hook system 110 and bottom fabric loop system 120), and back edge 130. Soap pocket scrubber system 100 further comprises first end 140 having first end rope 142, and second end 150 having second end rope 152. First end rope 142 and second end rope 152 comprise a sufficient length to allow for ease of drying, hanging, and reaching with relative ease even in awkward positioning. Multi-compartment pocket system 102 preferably comprises a plurality of soap pocket(s) and wherein each soap pocket(s) comprises individual compartment(s) 112. Compartment(s) 112 are located one adjacent the next and span the entire width from first end 140 to second end 150 such that all available space/material is used. This is desirable and specific dimensioning mentioned herein is preferred such that the device may be manufactured out of a standard sheet of material. Multi-compartment pocket system 102 may comprise first compartment 190, second compartment 192, third compartment 194, and fourth compartment 196. Each of the compartment(s) 112 preferably has an opening in front edge 108 such that at least one bar of soap 160 is insertable within each compartment(s) 112, as shown in FIG. 3.

Multi-compartment pocket system 102 preferably comprises permeable mesh fabric 170 such that bar of soap 160, when liquefied, can pass therethrough (substantially unrestricted to promote lather.) Top fabric hook system 110 and bottom fabric loop system 120 in combination, comprise hook and loop fastening system 124 suitable to open and close front edge 108. Hook and loop fastening system 124 preferably travels the length of the device to promote continuous securement along the length and to minimize manufacturing costs of cutting and aligning.

Front edge 108 preferably comprises top fabric hook system 110 and bottom fabric loop system 120 which are removably coupleable such that at least one bar of soap 160 is able to be inserted and enclosably-contained in each of the compartment(s) 112. Back edge 130 may comprise folded fabric so as to contain bar(s) of soap 160 within compartment(s) 112 but in some embodiments, may have a seamed edge and comprise different colors of fabric on first side 104 and second side 106. First end rope 142 comprises first loop 144 located on first end 140 and second end rope 152 comprises second loop 154 located on second end 150 such that a bather-user 180 is able to hold multi-compartment pocket system 102 via first loop 144 and second loop 154 to administer bar(s) of soap 160 to a body surface to lather and clean virtually any body surface, as well as difficult-to-reach areas of a human body.

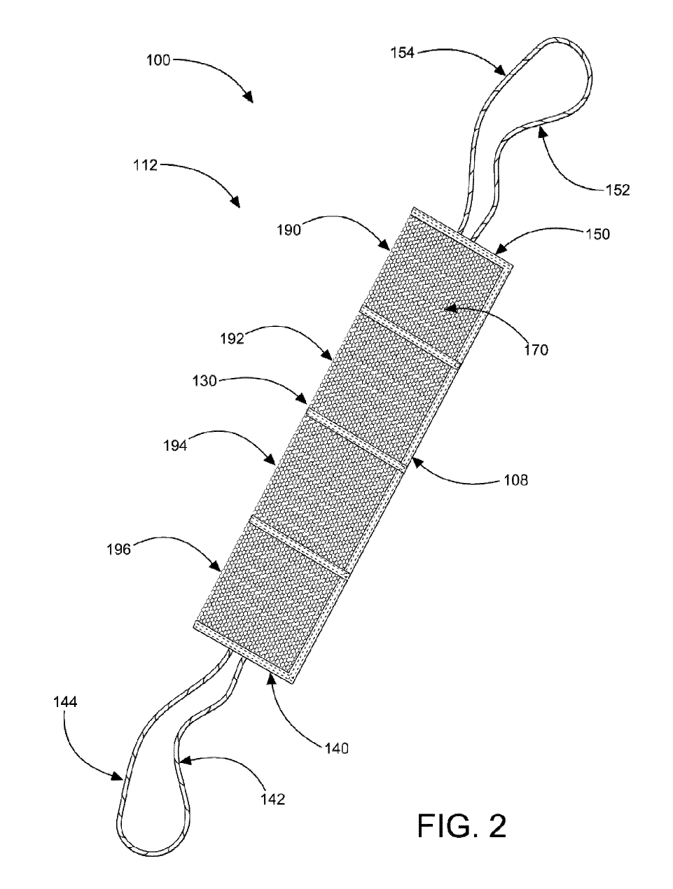

Referring now to FIG. 2, a perspective view illustrating soap pocket scrubber system 100 according to an embodiment of the present invention of FIG. 1.

Soap pocket scrubber system 100 comprises permeable mesh fabric 170 which tends to hold and increase lather of bar(s) of soap 160. Multi-compartment pocket system 102 is about 16 inches long and about 6 inches wide in preferred embodiments. Front edge 108 of multi-compartment pocket system 102 may comprise French Seams for easier gripping to separate and to decoratively cover top fabric hook system 110 and bottom fabric loop system 120. Multi-compartment pocket system 102 may comprise multiple layers of nylon permeable mesh fabric 170. First loop 144 and second loop 154 are preferably about 8 inches long and in addition to length of multi-compartment pocket system 102, the device is easy to apply pressure while pulling back and forth to scrub difficult to reach areas of the body such as the middle and upper back. Multi-compartment pocket system 102 fabric may contain colored images or sports logos in alternate embodiments to match room decor.

Referring now to FIG. 3, a perspective view illustrating insertion of bar(s) of soap 160 into soap pocket scrubber system 100 according to an embodiment of the present invention of FIGS. 1 and 2.

In a preferred embodiment, multi-compartment pocket system 102 comprises three compartment(s) 112, but other embodiments may have four compartment(s) 112, as shown in FIG. 3. Soap pocket(s) are able to contain one 5 ounce bar(s) of soap 160 each or able to contain multiple smaller bar(s) of soap 160. Soap pocket(s) of multi-compartment pocket system 102 are preferably about 4 inches long and about 4½ inches wide. Front edge 108 comprising top fabric hook system 110 and bottom fabric loop system 120 of multi-compartment pocket system 102 are about 1 inch wide and about 16 inches long.

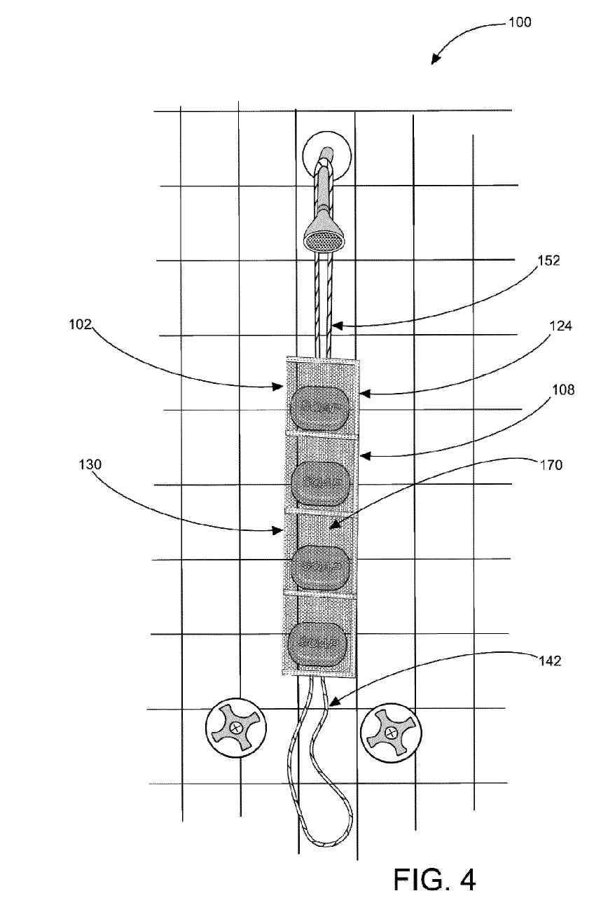

Referring now to FIG. 4, a perspective view illustrating soap pocket scrubber system 100 in a hang drying condition according to an embodiment of the present invention of FIG. 1.

Soap pocket scrubber system 100 comprises permeable mesh fabric 170 which tends to hold and increase lather of bar(s) of soap 160, during in-use condition such as shown in FIG. 1; however lather still passes through easily to a body surface. Mesh fabric 170 also acts to abrasively exfoliate when rubbed on the body, allowing dead skin cells to be removed, encouraging new cells to replace the removed cells. Multi-compartment pocket system 102 comprises nylon permeable mesh fabric 170 that is light weight and able to dry quickly even when multi-layered. Multi-compartment pocket system 102 is useful for abrasive exfoliation of skin of bather-user 180 encouraging healthier skin. Soap pocket scrubber system 100 is non-disposable in preferred embodiments and may be used multiple times over an extended period. Nylon permeable mesh fabric 170 is easily permeable by air, lather and water and when rinsed and hang-dried, hinders bacterial growth because of a short drying time.

Soap pocket scrubber system 100 according to an embodiment of the present invention of FIGS. 1-4, may be sold as kit 450 comprising the following parts: at least one multi-compartment pocket system 102 having first end rope 142 and second end rope 152; at least one bar(s) of soap 160 for insertion into soap pocket(s); and a set of user instructions. Soap pocket scrubber system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

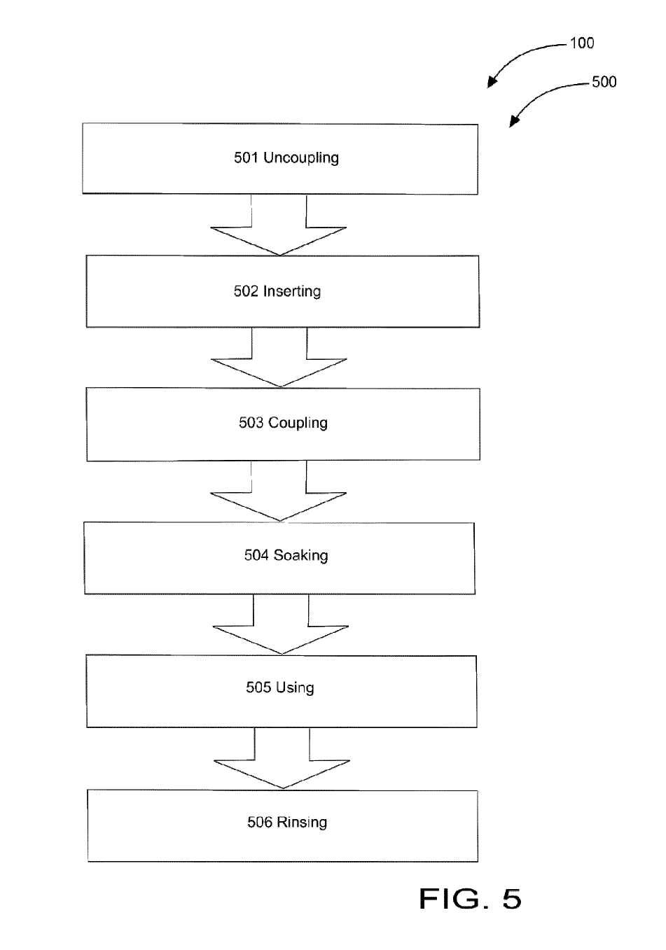

Referring now to FIG. 5, showing a flowchart illustrating a method of use 500 for soap pocket scrubber system 100 according to an embodiment of the present invention of FIGS. 1-4.

A method of use 500 for soap pocket scrubber systems 100 may comprise the steps of: step one 501 uncoupling hook and loop fastening system 124 for each compartment(s) 112 of soap pocket scrubber system 100; step two 502 inserting bar(s) of soap 160 in each of compartment(s) 112; step three 503 coupling hook and loop fastening system 124 for each compartment(s) 112 of soap pocket scrubber system 100; step four 504 soaking and lathering soap pocket scrubber system 100; step five 505 using soap pocket scrubber system 100 by gripping first end rope 142 in one hand and second end rope 152 in another hand and pulling back and forth across a hard-to-reach area of a body of bather-user 180; and step six 506 rinsing soap pocket scrubber system 100.

It should be noted that step 503 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A soap pocket scrubber system comprising:
a multi-compartment pocket system comprising;
a first side;
a second side;
a front edge comprising;
a top fabric hook system; and
a bottom fabric loop system;
a back edge;
a first end having a first end rope; and
a second end having a second end rope;
wherein said multi-compartment pocket system comprises a plurality of compartments;
wherein each of said compartments comprises an opening in said front edge such that at least one bar of soap is insertable within said compartment;
wherein said multi-compartment pocket system comprises a permeable mesh fabric such that said bar of soap, when liquefied can pass therethrough;
wherein said top fabric hook system and said bottom fabric loop system in combination comprise a hook and loop fastening system suitable to open and close said front edge;
wherein said front edge comprising said top fabric hook system and said bottom fabric loop system are removably couplable along their length such that said at least one bar of soap is able to be inserted and enclosably-contained in said compartment(s);
wherein said back edge comprises folded fabric so as to contain said bar(s) of soap within said compartment(s);
wherein said back edge is a seamed edge;
wherein said first end rope comprises a first loop located on said first end and said second end rope comprises a second loop located on said second end; and
wherein a bather-user is able to hold said multi-compartment pocket system via said first loop and said second loop to administer said bars of soap to a body surface to lather and clean said body surface also providing that said soap pocket scrubber system is usable to scrub difficult-to-reach areas of a human body.

2. The soap pocket scrubber system of claim 1 wherein said multi-compartment pocket system comprises a nylon net material that is light weight.

3. The soap pocket scrubber system of claim 2 wherein said nylon net material hinders bacterial growth.

4. The soap pocket scrubber system of claim 2 wherein said multi-compartment pocket system is about 16 inches long and about 6 inches wide.

5. The soap pocket scrubber system of claim 2 wherein said multi-compartment pocket system comprises multiple layers of said nylon net material.

6. The soap pocket scrubber system of claim 2 wherein said first loop and said second loop are about 8 inches long.

7. The soap pocket scrubber system of claim 2 wherein said multi-compartment pocket system comprises three of said compartments.

8. The soap pocket scrubber system of claim 2 wherein said multi-compartment pocket system comprises at least four of said compartments.

9. The soap pocket scrubber system of claim 1 wherein said soap pocket(s) of said multi-compartment pocket system are about 4 inches long and about 4½ inches wide.

10. The soap pocket scrubber system of claim 1 wherein said front edge comprising said top fabric hook system and said bottom fabric loop system of said multi-compartment pocket system are about 1 inch wide and about 16 inches long.

11. The soap pocket scrubber system of claim 1 wherein said multi-compartment pocket system comprising said nylon net material that is light weight which when used provides for abrasive exfoliation of skin of the bather-user.

12. The soap pocket scrubber system of claim 11 wherein said nylon net material comprises mesh.

13. The soap pocket scrubber system of claim 12 wherein said mesh holds and increases said lather of said bars of soap.

14. The soap pocket scrubber system of claim 1 wherein said soap pocket(s) are able to contain one 5 ounce said bar of soap each or multiple smaller said bars of soap.

15. The soap pocket scrubber system of claim 1 wherein the seams of said front edge of said multi-compartment pocket system comprise French Seams.

16. The soap pocket scrubber system of claim 1 wherein said soap pocket scrubber system is non-disposable.

17. The soap pocket scrubber system of claim 1 wherein said multi-compartment pocket system contains sports logos.

18. A soap pocket scrubber system comprising:
a multi-compartment pocket system comprising;
a first side;
a second side;
a front edge comprising;
a top fabric hook system; and
a bottom fabric loop system;
a back edge;
a first end having a first end rope; and
a second end having a second end rope;
wherein said multi-compartment pocket system comprises a plurality of compartments;
wherein said multi-compartment pocket system comprises three compartments;
wherein said soap pocket(s) of said multi-compartment pocket system are about 4 inches long and about 4½ inches wide;
wherein said soap pocket(s) are able to contain one 5 ounce said bar of soap each or multiple smaller said bars of soap;
wherein said multi-compartment pocket system comprises a nylon net material that is light weight;
wherein said multi-compartment pocket system wherein said nylon net material comprises mesh;
wherein said mesh holds and increases said lather of said bars of soap;
wherein said nylon net material hinders bacterial growth;
wherein said soap pocket scrubber system is non-disposable;
wherein said multi-compartment pocket system is about 16 inches long and about 6 inches wide;
wherein said multi-compartment pocket system comprises multiple layers of said nylon net material;
wherein said multi-compartment pocket system contains sports logos;
wherein each of said compartments comprises an opening in said front edge such that at least one bar of soap is insertable within said compartment;
wherein seams of said front edge of said multi-compartment pocket system comprise a French Seam to cover a hook and loop fastening system;
wherein said multi-compartment pocket system comprises a permeable mesh fabric such that said bar of soap, when liquefied can pass therethrough;
wherein said top fabric hook system and said bottom fabric loop system in combination comprise said hook and loop fastening system suitable to open and close said front edge;
wherein said front edge comprising said top fabric hook system and said bottom fabric loop system of said multi-compartment pocket system are about 1 inch wide and about 16 inches long;
wherein said front edge comprising said top fabric hook system and said bottom fabric loop system are removably couplable such that said at least one bar of soap is able to be inserted and contained in said compartments;
wherein said back end comprises folded fabric so as to contain said bar(s) of soap within said compartment(s);
wherein said first end rope comprises a first loop located on said first end and said second end rope comprises a second loop located on said second end;
wherein said first loop and said second loop are about 8 inches long;
wherein said multi-compartment pocket system comprising said nylon net material that is light weight provides for exfoliation of skin of a bather-user; and
wherein the bather-user is able to hold said multi-compartment pocket system via said first loop and said second loop to administer said bars of soap to a body surface to lather and clean said body surface also providing that said soap pocket scrubber system is usable to scrub difficult-to-reach areas of a human body.

19. The soap pocket scrubber system of claim 18 comprising a kit having:
at least one said multi-compartment pocket system having said first end rope and said second end rope;
at least one said bar of soap for insertion into said soap pocket(s); and
a set of user instructions.

20. A method of use for a soap pocket scrubber system comprising the steps of:
uncoupling a hook and loop fastening system for each compartment of the soap pocket scrubber system;
inserting a bar of soap in each said compartment;
coupling the said hook and loop fastening system for each said compartment of said soap pocket scrubber system;
soaking and lathering said soap pocket scrubber system;
using said soap pocket scrubber system by gripping a first end rope in one hand and a second end rope in another hand and pulling back and forth across a hard-to-reach area of a body of a user; and
rinsing the soap pocket scrubber system.
